(19) United States
(12) Patent Application Publication
(10) Pub. No.: US 2002/0023087 A1
(43) Pub. Date: Feb. 21, 2002

(54) System and method for recommending footwear

(76) Inventors: J. Michael Vickery, Palo Alto, CA (US); Gregory Banting, Sausalito, CA (US)

Correspondence Address: Marc A. Sockol, Squire, Sanders & Dempsey L.L.P., 600 Hansen Way, Palo Alto, CA, 94304-1043, US

(21) Appl. No.: 09/839,705

(22) Filed: Apr. 19, 2001

Related U.S. Application Data
(60) Provisional application No. 60/198,015, filed on Apr. 18, 2000.

(51) Int. Cl. G06F 7/00

(52) U.S. Cl. 707/7

(57) ABSTRACT

A method which comprises obtaining footwear information corresponding to preferred footwear of a user, comparing the footwear information against stored footwear information corresponding to alternative footwear, and determining recommended footwear from the alternative footwear based on the comparison.

### PRIORITY CLAIM

This application claims priority to and incorporates by reference provisional application Ser. No. 60/198,015, entitled “System and Method for Selecting Footwear and Determining Shoe Size Via the Internet” filed on Apr. 19, 2001 by inventors Vickery et al.

### BRIEF DESCRIPTION OF THE DRAWINGS

FIG. 1 is a flowchart illustrating a method of recommending footwear.

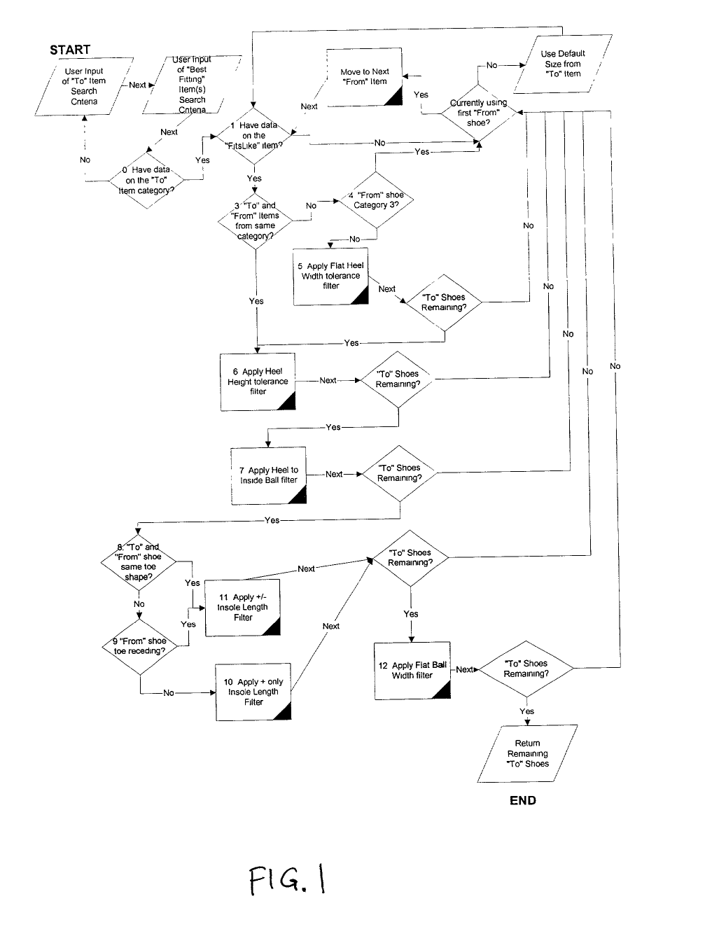

### SHOE SELECTION PROCESS

A process for selecting the most appropriate shoes for footwear consumers based on comparing the fit characteristics of existing shoes with that of shoes that match selection criteria defined by the customer.

The fit characteristics are a set of measurements taken from shoes or shoe lasts (models from which shoes are built) and include dimensional data as well as information about style and composition that affect fit. This data is stored in a database and is compared with that of comfortable favorites already worn by the customer.

The process is invoked on the FitsLike website with the customer providing the following information:

1. Selection criteria (M/F, Category, Normal Size, etc) for shoes that they are interested in purchasing. These shoes become the “To” shoes and are candidates for recommendation.

2. Information about current shoes (Brand, Size, Style Number OR Style Name). These are the “From” shoes (It is suggested that the customer provide information on 2 pair).

3. Additional fitting information.

Process Detail

Step 0: ‘To’ shoe search criteria is input by customer or extracted from host application.

Step 1: Customer inputs ‘Best Fitting’ Items search criteria (‘From’ shoes) including Brand, Style, Style No., and Size.

Step 2: If have data on ‘To’ Item category, proceed to next step. If not, return to Step 0.

Step 3: Determine whether the first ‘From’ shoe is in database. If yes, proceed to next step. If no, check the second ‘From’ shoe. If no, customer must enter another ‘From’ shoe.

Step 4: Determine whether ‘To’ and ‘From’ shoes are of the same Category:

Men's

1. Oxford, Loafer, Boot

2. Athletic

3. Sandal, Moccasin, Clog

Women's

1. Oxford, Loafer, Boot

2. Athletic

3. Sandal, Moccasin, Clog

4. Mule, Pump

If yes, proceed to Step 7, If no, go to next step.

Step 5: If ‘From’ shoe is not Category 3, proceed to next Step. If ‘From’ shoe is a Category 3 (Moccasin, Sandal, or Clog), repeat process with beginning at Step 3 with second ‘From’ shoe. If this is the second ‘From’ shoe, a message must be sent to customer indicating that they must enter another pair of “From” shoes that is not a Moccasin, Sandal, or Clog. The process must then begin again from Step 1.

Step 6: Select ‘To’ shoes with Flat Heel Width within +/− 1/32 in. (0.03125 in.) of ‘From’ shoe.

If no ‘To’ shoes are remaining, repeat process beginning at Step 3 with second ‘From’ shoe. If this is the second or subsequent ‘From’ shoe, customer must enter another ‘From’ shoe and the process must begin again from Step 1.

Step 7: Select ‘To’ shoes with Heel Height within +/− ⅜ in. (0.375 in.) of ‘From’ shoe.

If no ‘To’ shoes are remaining, repeat process beginning at Step 3 with second ‘From’ shoe. If this is the second or subsequent ‘From’ shoe, customer must enter another ‘From’ shoe and the process must begin again from Step 1.

Step 8: Further Select ‘To’ shoes with Heel-to-Inside Ball within +⅛ in. (0.125 in.)

If no ‘To’ shoes are remaining, repeat process beginning at Step 3 with second ‘From’ shoe. If this is the second or subsequent ‘From’ shoe, customer must enter another ‘From’ shoe and the process must begin again from Step 1.

Step 9: Further Select ‘To’ shoes by comparing Insole Length. First, Toe Shape Description must be compared. Select ‘To’ Shoes with the same Toe Shape as the ‘From’ shoe and proceed to Step 13.

Step 10: If ‘From’ shoe has a Receded Toe, proceed to Step 13.

Step 11: If ‘From’ shoe has a Walled Toe, select ‘To’ shoes with an Insole Length within +1/12 in. (0.0833 in.), and proceed to Step 14.

If no ‘To’ shoes are remaining, repeat process beginning at Step 3 with second ‘From’ shoe. If this is the second or subsequent ‘From’ shoe, customer must enter another ‘From’ shoe and the process must begin again from Step 1.

Step 12: Further Select ‘To’ shoes with an Insole Length within +/− 1/12 in. (0.0833 in.) of ‘From’ shoe.

If no ‘To’ shoes are remaining, repeat process beginning at Step 3 with second ‘From’ shoe. If this is the second or subsequent ‘From’ shoe, customer must enter another ‘From’ shoe and the process must begin again from Step 1.

Step 13: Further Select ‘To’ shoes with Flat Ball Width within +/− 1/16 in. (0.0625 in.) of ‘From’ shoe.

If no ‘To’ shoes are remaining, repeat process beginning at Step 3 with second ‘From’ shoe. If this is the second or subsequent ‘From’ shoe, customer must enter another ‘From’ shoe and the process must begin again from Step 1.

Step 14: Recommend the remaining ‘To’ shoes to customer.

### Size Selection Process

A process for determining the appropriate size of a desired shoe selected by a footwear customer by comparing the fit characteristics of existing shoes with that of the desired shoe.

The fit characteristics are a set of measurements taken from shoes or shoe lasts (models from which shoes are built), and include dimensional data as well as information about style and composition that affect fit. This data is stored in a database and is used to determine the size of a desired shoe that falls within acceptable tolerance levels.

Process Detail

Step 1: Customer enters information about current shoes (Brand, Size, Style Number OR Style Name) and whether they are male or female. This is the ‘From’ shoe.

Step 2: Determine whether “From” shoe is in database. If yes, proceed to Step 4. If no, customer must enter another “From” shoe.

Step 3: Categorize ‘To’ and ‘From’ shoes into one of following seven Categories:

Men's

1) Oxford, Loafer, Boot

a) Dress

b) Casual

2) Athletic

3) Sandal, Moccasin, Clog

Women's

1) Oxford, Loafer, Boot

a. Dress

b. Casual

2) Athletic

3) Sandal, Moccasin, Clog

4) Mule, Pump

Step 4: Compare Shoe Category. ‘To’ and ‘From’ must be from the same Category (i.e. Men's Category 1 to Men's Category 1). If same, proceed to Step 6. If different, proceed to Step 5.

Step 5: If ‘From’ shoe is not Category 3, proceed to Step 6. If ‘From’ shoe is a Category 3 (Moccasin, Sandal, or Clog), repeat process with second ‘From’ shoe. If second ‘From’ shoe is Category 3, customer must enter another pair of “From” shoes that is not a Moccasin, Sandal, or Clog which will reinitiate process from Step 2.

Step 6: Compare Heel Height. If ‘To’shoe has a Heel Height within +/− ⅜ in. proceed.

If not, check restart process with second ‘From’ shoe. If no match with second ‘From’ shoe, customer must reinitiate process from Step 1.

Step 7: Compare Heel-to-Inside Ball of ‘From’ shoe to available sizes of ‘To ’ (desired) shoe. Select size (length) within +⅛ in. and proceed (Note: ‘To ’ shoe cannot be shorter than ‘From’ shoe).

Step 8: Compare Toe Shape. If Toe Shapes are the same, proceed to Step 11.

Step 9: If ‘From’ shoe has a Receded Toe, proceed to Step 11.

Step 10: If ‘From’ shoe has a Walled Toe, Overall Length of selected ‘To ’ shoe must be within +1/12 in. to proceed to Step 12. If not, check restart process with second ‘From’ shoe. If no match with second ‘From’ shoe, customer must reinitiate process from Step 1.

Step 11: Compare Overall Length. If ‘To ’ shoe is within +/− 1/12 in. proceed to Step 12.

If not, check restart process with second ‘From’ shoe. If no match with second ‘From’ shoe, customer must reinitiate process from Step 1.

Step 12: Compare Flat Ball Width of ‘From’ shoe to available widths of ‘To ’ shoe. Select width within +/− 1/16 in. of ‘From’ shoe and proceed to Step 13. If not, check restart process with second ‘From’ shoe. If no match with second ‘From’ shoe, customer must reinitiate process from Step 1.

Step 13: Recommend length and width of ‘To ’ shoe as proper size.

The foregoing description of the illustrated embodiments is by way of example only, and other variations and modifications of the above-described embodiments and methods are possible in light of the foregoing teaching. Components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What I claim is:

1. A method, comprising:
obtaining footwear information corresponding to preferred footwear of a user;
comparing the footwear information against stored footwear information corresponding to alternative footwear; and
determining recommended footwear from the alternative footwear based on the comparison.

2. The method of claim 1, further comprising obtaining identification information identifying the preferred footwear from the user.

3. The method of claim 2, wherein the obtaining of footwear information includes obtaining from a database fit characteristics of the preferred footwear.

4. The method of claim 3, wherein the determining of recommended footwear includes comparing the footwear information of the alternative footwear against predetermined tolerances relative to the footwear information of the preferred footwear.

5. A system, comprising:
means for obtaining footwear information corresponding to preferred footwear of a user;
means for comparing the footwear information against stored footwear information corresponding to alternative footwear; and
means for determining recommended footwear from the alternative footwear based on the comparison.

6. A computer-readable storage medium storing program code for causing a computer to perform:
obtaining footwear information corresponding to preferred footwear of a user;
comparing the footwear information against stored footwear information corresponding to alternative footwear; and
determining recommended footwear from the alternative footwear based on the comparison.

7. A system, comprising:
a database storing footwear information corresponding to footwear;
memory storing program code configured to obtain footwear information corresponding to preferred footwear of a user, for comparing the footwear information against the stored footwear information, and for determining recommended footwear from the alternative footwear based on the comparison; and
a processor for controlling the program code in the memory.
